(19) United States
(12) Patent Application Publication
(10) Pub. No.: US 2025/0015326 A1
(43) Pub. Date: Jan. 9, 2025

(54) Air Supply of Fuel Cell and Pneumatic System

(71) Applicant: KNORR-BREMSE Systeme fuer Nutzfahrzeuge GmbH, Muenchen (DE)

(72) Inventors: Sven Philip KRUEGER, Muenchen (DE); Rainer WINZER, Muenchen (DE); Dordo STANKOVIC, Muenchen (DE); Yves COMPERA, Garching bei Muenchen (DE); Thomas FELDT, Erding (DE); Tobias SCHOEFBERGER, Mainburg (DE); Philipp ADAMCZYK, Bernried (DE); Korbinian HEIGL, Muenchen (DE)

(21) Appl. No.: 18/761,774

(22) Filed: Jul. 2, 2024

(30) Foreign Application Priority Data
Jul. 3, 2023 (DE) 10 2023 117 432.0

(51) Int. Cl. H01M 8/04746; H01M 8/0438; H01M 8/0662

(52) U.S. Cl. CPC H01M 8/04776; H01M 8/04425; H01M 8/0687

(57) ABSTRACT

An air supply system for a fuel cell unit and a pneumatic system includes: a fuel cell compressor which is designed to induct air from its intake side and by way of its outlet side convey said air to a fuel cell outlet of the air supply system, the fuel cell outlet being able to be connected to a fuel cell unit; a pneumatic system compressor which is designed to induct air from its intake side and by way of its outlet side convey the air to a pneumatic system outlet of the air supply system, the pneumatic system outlet being able to be connected to a pneumatic system; an intake opening; a fuel cell intake line which connects the intake side of the fuel cell compressor to the intake opening; and a pneumatic system intake line which connects the intake side of the pneumatic system compressor to the intake opening. The fuel cell compressor and the pneumatic system compressor can induct air by way of the intake opening.

### CROSS REFERENCE TO RELATED APPLICATION

This application claims priority under 35 U.S.C. § 119 from German Patent Application No. 102023117432.0, filed Jul. 3, 2023, the entire disclosure of which is herein expressly incorporated by reference.

### BACKGROUND AND SUMMARY

The present invention relates to a possibility of supplying air to a fuel cell and a pneumatic system of a vehicle, and to a vehicle.

As on-road vehicles, in particular commercial vehicles, are increasingly electrified, the use of fuel cells is gaining in importance. In this field of application, fuel cells usually utilize the oxygen in the air as an oxidant, and conjointly with a fuel (usually hydrogen) generate an electric current which is then in particular used for supplying the electric drive machine(s) in the vehicle. In addition, further consumers can be operated by the current from the fuel cell.

Moreover, some vehicles, in particular in the commercial vehicle sector, have pneumatic systems which require compressed air for operation. This compressed air is generated in the vehicle by means of compressors in that ambient air is inducted and, after corresponding treatment, used as compressed air. Such a pneumatic system can in particular be a pneumatic brake system which is completely, or at least in part, operated by means of compressed air. This hereunder may be a brake system with active components, thus components which generate a braking action by virtue of an introduced pressure, as well as passive components which generate a braking action by virtue of a drop in pressure. For example, an actuator of a service brake of the vehicle can be understood to be an active component. This actuator brings the frictional components of the brake (e.g. brake pads and brake disk or brake drum) into mutual contact in order to generate a braking action when a pneumatic pressure is introduced. A spring-loaded brake can be considered to be a passive component, for example. This spring-loaded brake brings the corresponding frictional components of the brake into mutual contact in order to generate a braking action by virtue of a relaxing spring as soon as there is a drop in the pneumatic pressure, or when compressed air which previously compressed the spring is discharged. Moreover, an air suspension system is to be mentioned as a further pneumatic system. This air suspension system generates a spring action for the vehicle superstructure by virtue of an air cushion. Moreover, a control of the ride height, or the spring action per se, and thus also the movement of the superstructure, may be provided.

Because the air supply to the fuel cells as well as to the pneumatic systems takes place in a mutually independent manner, it is an object of the present invention to provide an improvement in comparison to the prior art to date.

This object is achieved by the subject matter of the independent claims.

Advantageous refinements are the subject matter of the dependent claims.

Preferably provided is an air supply system for a fuel cell unit and for a pneumatic system. The air supply system has the following:
a fuel cell compressor which is designed to induct air from its intake side and by way of its outlet side convey said air to a fuel cell outlet of the air supply system, said fuel cell outlet being able to be connected to a fuel cell unit;
a pneumatic system compressor which is designed to induct air from its intake side and by way of its outlet side convey said air to a pneumatic system outlet of the air supply system, said pneumatic system outlet being able to be connected to a pneumatic system;
an intake opening;
a fuel cell intake line which connects the intake side of the fuel cell compressor to the intake opening; and
a pneumatic system intake line which connects the intake side of the pneumatic system compressor to the intake opening; wherein
the fuel cell compressor as well as the pneumatic system compressor can induct air by way of the intake opening.

The term “fuel cell unit” comprises individual fuel cells as well as a plurality of fuel cells and also a plurality of fuel cell stacks. In the process, air is conveyed to the individual fuel cell or the plurality of fuel cells by the air supply system. The term “fuel cell unit” thus comprises different configurations of fuel cells as used in automotive engineering.

The term “intake side” describes the low-pressure side of the respective compressor, while the high-pressure side of the respective compressor is described by the term “outlet side”.

The terms “fuel cell outlet” and “pneumatic system outlet” are used to describe the outlet sides of the air supply system, by way of which the air is conveyed to the fuel cell unit, or the pneumatic system, respectively. The fuel cell outlet, or the pneumatic system outlet, can be of different embodiments, respectively. It can be provided in particular that the fuel cell outlet and/or the pneumatic system outlet have/has one or a plurality of line connections to the fuel cell unit, or to the pneumatic system, respectively.

The terms “fuel cell intake line” and “pneumatic system intake line” are used to describe the line connections that implement a connection from the intake opening to the respective intake sides of the fuel cell compressor, or of the pneumatic system compressor, respectively. The line connections can in particular be implemented by corresponding piping or hose lines. However, it is also possible that said line connections are completely, or at least in part, formed as a constituent part of a housing. Alternatively, it is also possible that at least one intake line is implemented only as a constituent part of a compressor. In any case, the term “ . . . intake line” is not to be understood to mean that a specific minimum line length has to be implemented. These intake lines are moreover to be understood in such a way that they emanate from a common line point which is connected to the intake opening. This means that separate air paths are present from this point, which lead to the fuel cell compressor on the one hand, and to the pneumatic system compressor on the other hand.

The invention thus discloses an air supply system which has a reduced number of intake openings in comparison to known systems. Owing to the fact that the intake opening is used to induct air by the fuel cell compressor as well as by the pneumatic system compressor, fewer intake openings have to be provided, and it is moreover possible to dispense with lines. Moreover, it may be possible that—in addition to the pneumatic system—at least one further pneumatic system can be connected to the air supply system.

The intake opening preferably has an air filter. Since the air filter is placed in the intake opening, the fuel cell compressor as well as the pneumatic system compressor inducting air through said intake opening, the air filter is advantageously adapted in such a way that it meets the respective more stringent requirements. This means that if the requirement of the fuel cell unit in terms of the filter is higher than that of the pneumatic system, the air filter is preferably designed in such a way that it meets the requirements of the fuel cell unit. For example, the air that is supplied to the fuel cell unit has to be relieved of particles such as dirt, soot and the like, on the one hand, and on the other hand it is also necessary that also gases such as NOx, NH₃, etc. are filtered from the inducted air for the fuel cell unit. If the pneumatic system is a pneumatic brake system or an air suspension system, it is sufficient to only filter the particles from the inducted air for this purpose. In this case, the requirement set for the filter by the fuel cell unit is higher. However, in this case the pneumatic system can also use the air relieved of gases. Of course, the converse case in which a pneumatic system is used that sets higher requirements for the air filter than the fuel cell unit is also contemplated.

The use of the common filter utilized by the fuel cell unit and the pneumatic system ultimately results in a further air filter being able to be dispensed with. The air that is inducted by this air filter is preferably already treated in such a way that said air can be supplied to the fuel cell unit as well as to the pneumatic system.

Alternatively or additionally, the fuel cell intake line has a separate air filter. The latter can be designed in such a way that it cleans the inducted air in the fuel cell intake line so as to meet the requirements of the fuel cell unit.

Alternatively or additionally, the pneumatic system intake line has a separate air filter. The latter can be designed in such a way that it cleans the inducted air in the pneumatic system intake line so as to meet the requirements of the pneumatic system.

However, it is also contemplated that the common air filter which is provided in the intake opening handles only basic cleaning of the inducted air. Depending on the requirement, a separate air filter may then be provided in the fuel cell intake line or in the pneumatic system intake line for further cleaning of the inducted air. For example, the air supply system in this instance can be configured in such a way that basic cleaning by the air filter provided in the intake opening is sufficient for delivering air to the fuel cell unit or to the pneumatic system. Further cleaning is then performed by the air filter provided in the respective intake line. For example, it can thus be provided that the common air filter ensures cleaning of the inducted air so as to be sufficient for the pneumatic system, so that a further air filter is no longer provided in the pneumatic system intake line in this case. This can be the case when the pneumatic system is a pneumatic brake system or an air suspension system. Instead, a further air filter for treating the air for the fuel cell unit can be provided in the fuel cell intake line, said further air filter then further cleaning the intake air pre-cleaned by the common air filter in such a way that said air also meets the requirements of the fuel cell unit.

Such a configuration does indeed have the disadvantage that at least one further air filter which meets higher requirements is required in comparison to the use of a single common air filter, however this air filter can be embodied so as to be of a smaller construction than a single common air filter. Moreover, the flow resistance for the compressor that does not require any further air filter in the intake line can be improved in this way, because said compressor has to induct air only against the resistance of the air filter in the intake opening.

The air supply system on the outlet side of the fuel cell compressor and/or at the fuel cell outlet preferably has a detection means which is designed to detect the mass flow of air conveyed by the fuel cell compressor and/or the pressure generated by the fuel cell compressor. For this purpose, the detection means can have a pressure sensor and/or an air-mass flow sensor.

The air supply system on the outlet side of the pneumatic system compressor and/or at the pneumatic system outlet preferably has a detection means which is designed to detect the mass flow of air conveyed by the pneumatic system compressor and/or the pressure generated by the pneumatic system compressor. For this purpose, the detection means can have a pressure sensor and/or an air-mass flow sensor.

The pneumatic system intake line preferably has a valve which, in a first switch position, is designed to establish the connection between the intake opening and the intake side of the pneumatic system compressor and, in a second switch position, to interrupt the connection between the intake opening and the intake side of the pneumatic system compressor. It is thus possible to block the pneumatic system compressor in relation to the intake opening by the valve.

The valve, in the second switch position, is preferably designed to establish a connection of the intake side of the pneumatic system compressor to the outlet side of the fuel cell compressor. It is made possible in this way to allow compressed air, which the fuel cell compressor conveys on its outlet side, to be inducted by the pneumatic system compressor. For this purpose, the connection between the intake opening and the pneumatic system compressor is advantageously interrupted by the second switch position of the valve, as described above. A pressure level which is higher than that of the environment is now prevalent on the intake side of the pneumatic system compressor, because the fuel cell compressor is thus utilized as a first compressor stage in that compressed air which is ejected by the pneumatic system compressor is conveyed to the intake side of the pneumatic system compressor.

The air supply system is preferably designed so that in the second switch position of the valve there is additionally a connection from the outlet side of the fuel cell compressor to the fuel cell outlet. In this way, it is possible for the fuel cell unit to be supplied by the fuel cell compressor on the one hand, while it is possible to supply the pneumatic system compressor on the other hand, for example by way of the line which branches off from the outlet side of the fuel cell compressor and in the second switch position of the valve leads to the intake side of the pneumatic system compressor.

It applies in general that as soon as the outlet side of the fuel cell compressor is connected to the intake side of the pneumatic system compressor, the fuel cell compressor can function as a blower, or as a first compressor stage, for the pneumatic system compressor. This has the advantage that the pneumatic system compressor no longer has to compress the inducted air to the same extent as would be the case if said inducted air were inducted directly from the conjointly used intake opening.

By way of example, a configuration in which the pneumatic system compressor is operated as a compressor for a pneumatic brake system is mentioned here. This means that compressed air at the pneumatic system outlet is conveyed to a pneumatic brake system connected to the latter. The air which leaves the fuel cell compressor on the outlet side usually has a pressure of 2 to 3 bar. This meets the requirements of the fuel cell unit. In contrast, the pneumatic system compressor is operated in such a way that a pressure of 12 to 13 bar is prevalent on its outlet side. This meets the requirements of the pneumatic brake system. It is clearly evident from this example that the pneumatic system compressor now no longer has to overcome a pressure difference of 12 to 13 bar. Instead, the pressure difference to be overcome is now only 9 to 11 bar because the fuel cell compressor is utilized as a blower. The specific energy consumption of the pneumatic system compressor can be reduced in this way.

The fuel cell compressor can be utilized as a blower for the pneumatic system compressor in particular if the required mass flow that has to be conveyed by the pneumatic system compressor is substantially less than the mass flow that the fuel cell compressor has to convey. The mass flow of the pneumatic system compressor is preferably less than 1% of the mass flow of the fuel cell compressor. The mass flow of the pneumatic system compressor particularly preferably is less than 0.5% of the mass flow of the fuel cell compressor.

For example, if the mass flow that the pneumatic system compressor has to convey to a pneumatic brake system is 0.5 g/s, the mass flow conveyed by the fuel cell compressor can thus be 120 g/s.

The air supply system is preferably designed to switch the valve to the first switched state or to maintain the first switched state if a first condition is met. The air supply system can have correspondingly designed control means for switching the valve, or for processing the first condition. These control means can have in particular an electronic control apparatus, or be designed as such. Furthermore, a connection from the above-mentioned detection means to the control means can be provided, so that variables detected by way of the detection means are available to the control means.

The first condition is preferably undershooting or remaining below a first predetermined limit by the pressure or by the mass flow of air on the outlet side of the fuel cell compressor and/or at the fuel cell outlet. In this case, too little air is delivered to the fuel cell unit. In order to connect the pneumatic system compressor directly to the intake opening in this instance, the valve is switched to the first switched state, or the latter is maintained. It is thus ensured that the pneumatic system compressor inducts air directly from the intake opening and no air is branched off from the outlet side of the fuel cell compressor, all of said air being actually required for the fuel cell unit.

Alternatively or additionally, the first condition can be a predetermined operating state of the air supply system. For example, it can be provided that a direct connection of the intake side of the pneumatic system compressor is then established or maintained by the first switched state of the valve if a high quality of control of the pneumatic system compressor or of the fuel cell compressor is required. It is ensured in this case that the pneumatic system compressor is connected directly to the intake opening. In this way, the two compressors do not influence one another.

It is to be clarified at this point that the term “valve” as used above and hereunder may describe a single valve which can accordingly assume the first and the second switched state. In this way, a single, in particular controllable, valve can preferably be provided so as to in particular switch the fuel cell compressor and the pneumatic compressor to an operation in series in such a way that the fuel cell compressor functions as a blower for the pneumatic system compressor. However, it is likewise possible to provide a plurality of interconnected valves which are actuated in such a way that said valves in terms of their functionality can implement a first and a second switched state as has been described above. The term “valve” thus comprises both, specifically a single valve and a plurality interconnected valves.

The air supply system is preferably designed to increase the power input of the fuel cell compressor and/or to reduce a flow resistance on the outlet side of the fuel cell compressor and/or at the fuel cell outlet if the valve is in the second switched state and a second condition is met. The increase in the power input of the fuel cell compressor can take place by correspondingly activating the fuel cell compressor by a control means which can be identical to the above-mentioned control means or be different from the latter. In this case, a rotating speed of the fuel cell compressor is increased, for example. In order to reduce the flow resistance, an adjustable throttle or throttle flap which is provided on the outlet side of the fuel cell compressor and/or at the fuel cell outlet can be actuated, for example. The adjustable throttle or throttle flap can also be provided within the fuel cell unit connected to the fuel cell outlet. For example, such an adjustable throttle within the fuel cell unit can be provided after the actual fuel cell stack. This adjustable throttle generates a counterpressure for air that flows through the fuel cell unit, or forms a flow resistance for this air. Therefore, by correspondingly activating this adjustable throttle, the air supply system can reduce the counterpressure, or the flow resistance, respectively. In general, the air supply system preferably has a correspondingly designed control means for this purpose, which can be identical to the above-mentioned control means, or be different therefrom.

The second condition is preferably undershooting or remaining below a second predetermined limit by the pressure or by the mass flow of air on the outlet side of the fuel cell compressor and/or at the fuel cell outlet. This is in particular the case if the valve is in the second switched state and the fuel cell compressor is used as a blower of the pneumatic system compressor. In this case, not all the air at the outlet of the fuel cell compressor is directed to the fuel cell outlet and thus to the fuel cell unit. Part is inducted by the pneumatic system compressor, which can lead to a pressure loss or to an air-mass flow loss at the fuel cell outlet or at the outlet of the fuel cell compressor. This can at least be partially, preferably completely, compensated for by correspondingly activating the fuel cell compressor.

Alternatively or additionally, the second condition can be a predetermined operating state of the air supply system. This can be the case in particular if an increased output requirement of the pneumatic system and/or of the fuel cell unit is required, which must be met by means of a previously established operation of the respective compressor. For example, if the pneumatic system has compressed air reservoirs which have to be filled, such as can be the case when starting the vehicle from a parked state, for example, if the pneumatic system is a pneumatic brake system or an air suspension system, this predetermined additional requirement of the pneumatic system can be compensated for by increasing the power input of the fuel cell compressor and/or by reducing the flow resistance on the outlet side of the fuel cell compressor and/or at the fuel cell outlet, whereby it is preferably possible to continue the supply to the fuel cell unit at the same time.

As has already been mentioned above by way of example, the pneumatic system can comprise a pneumatic brake system and/or an air suspension system, or be designed as a pneumatic brake system and/or as an air suspension system.

A buffer tank is preferably provided in the pneumatic system intake line, or on the intake side of the pneumatic system compressor. The buffer tank can be designed to equalize or reduce pressure or mass flow fluctuations emanating from the outlet side of the fuel cell compressor.

A vehicle which can in particular be designed as a commercial vehicle is furthermore preferably provided. The vehicle has a fuel cell unit or a plurality of fuel cell units, a pneumatic system or a plurality of pneumatic systems, and an air supply system as described above. The fuel cell outlet of the air supply system is connected to the fuel cell unit or the fuel cell units. The pneumatic system outlet of the air supply system is connected to the pneumatic system or the pneumatic systems. In this way, the air supply system can convert air, which is inducted by way of the intake opening of the air supply system, to the fuel cell unit or fuel cell units connected to the air supply system and to the pneumatic system connected to the air supply system, or to the pneumatic systems connected to the air supply system.

The pneumatic system or the pneumatic systems of the vehicle can comprise a pneumatic brake system and/or an air suspension system. The pneumatic system or the pneumatic systems of the vehicle can in particular be designed as a pneumatic brake system and/or as an air suspension system.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic diagram of an embodiment of an air supply system.

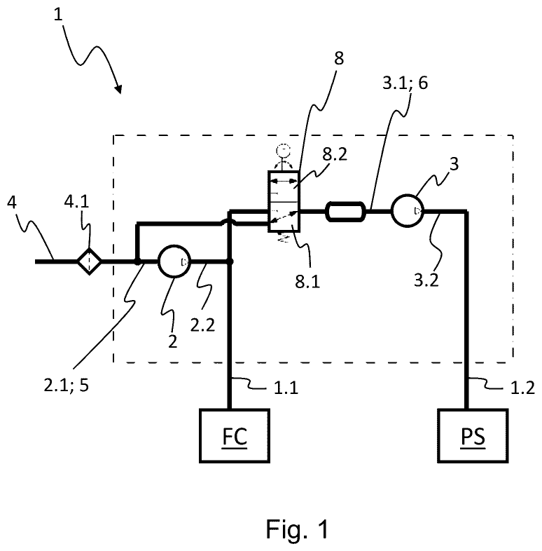

### DETAILED DESCRIPTION OF THE DRAWING

Shown is an air supply system 1 for a fuel cell unit FC and for a pneumatic system PS.

The air supply system 1 has the following:
a fuel cell compressor 2 which is designed to induct air from its intake side 2.1 and by way of its outlet side 2.2 convey said air to a fuel cell outlet 1.1 of the air supply system 1, said fuel cell outlet 1.1 being able to be connected to a fuel cell unit FC;
a pneumatic system compressor 3 which is designed to induct air from its intake side 3.1 and by way of its outlet side 3.2 convey said air to a pneumatic system outlet 1.2 of the air supply system 1, said pneumatic system outlet 1.2 being able to be connected to a pneumatic system PS;
an intake opening 4;
a fuel cell intake line 5 which connects the intake side 2.1 of the fuel cell compressor 2 to the intake opening 4; and
a pneumatic system intake line 6 which connects the intake side 3.1 of the pneumatic system compressor 3 to the intake opening 4; wherein
the fuel cell compressor 2 as well as the pneumatic system compressor 3 can induct air by way of the intake opening 4.

Furthermore illustrated in the drawing are a fuel cell unit FC and a pneumatic system PS. The fuel cell unit FC is connected to the fuel cell outlet 1.1. The pneumatic system PS is connected to the pneumatic system outlet 1.2. In the configuration illustrated, air can thus be conveyed to the pneumatic system PS and to the fuel cell unit FC by way of the intake opening 4.

The pneumatic system PS can comprise a pneumatic brake system and/or an air suspension system, or can be designed such.

The configuration shown can in particular be part of a vehicle according to the invention, which has the fuel cell unit FC shown and the pneumatic system shown.

The air supply system 1 has the following functional modes.

The intake opening 4 has an air filter 4.1 by which inducted ambient air is filtered. The air filter 4.1 herein can be designed in such a way that the air is cleaned in such a way that the latter after the air filter 4.1 meets the requirements of the fuel cell unit FC and the pneumatic system PS, depending on which requirements are more stringent. As explained above, this can in particular comprise the filtration of particles and gases, which meets the requirements of the fuel cell unit FC, while the pneumatic system PS only requires intake air from which particles have been cleaned.

Alternatively however (not shown), it can also be provided that the air filter 4.1 meets only the minimum requirement of the fuel cell unit FC and of the pneumatic system PS, and that a second air filter is provided on the intake side 2.1 or on the intake side 3.1 so as to further filter air filtered by the air filter 4.1 in such a way that said air also meets the correspondingly more stringent requirements of the system connected thereto, specifically of the fuel cell unit FC, or of the pneumatic system PS, respectively.

Besides the compressors 2, 3 shown, which can both induct air from the intake opening 4 by way of separate intake lines 5, 6, a valve 8 which has a first switch position 8.1 and a second switch position 8.2 is provided. In the illustration shown, the valve 8 is in the first switch position 8.1. In this switch position 8.1, the outlet sides 2.2 and 3.2 of the compressor is 2, 3 are connected to the respective outlets 1.1 and 1.2 of the air supply system 1. In this switch position, the outlet side 2.2 of the fuel cell compressor 2 is blocked in relation to the intake side 3.1 of the pneumatic system compressor 3.

If the valve 8 is switched to the second switch position 8.2, the intake side 3.1 of the pneumatic system compressor 3 is disconnected from the intake opening 4 and instead connected to the outlet side 2.2 of the fuel cell compressor 2. In this state, the fuel cell compressor 2 conveys air to the fuel cell outlet 1.1 and thus to the fuel cell unit FC on the one hand, and to the intake side 3.1 of the pneumatic system compressor 3 on the other hand. For this purpose, the line on the outlet side 2.2 of the fuel cell compressor 2 has a corresponding branch which leads to the fuel cell outlet 1.1 on the one hand, and to the valve 8 on the other hand. In this switch position, the fuel cell compressor 2 thus functions as a blower for the pneumatic system compressor 3. In this switched state, the latter therefore no longer has to perform the full compression work in comparison to the situation if said pneumatic system compressor 3 were to induct air directly by way of the intake opening 4.

As a result of the fuel cell compressor 2 functioning as a blower, the pressure, or the mass flow of air, also drops on the outlet side 2.2 of the fuel cell compressor 2, so that too little air is potentially conveyed to the fuel cell unit FC. In order for this to be compensated for, the air supply system can increase the power input of the fuel cell compressor 2, for example in that the rotating speed of the latter is increased in such a way that the pressure loss, or the air-mass flow loss, at the outlet 2.2, or at the fuel cell outlet 1.1, respectively, are compensated for. It can moreover be provided that the valve 8 returns to the first switched state 8.1 if, for example, a compensation by the fuel cell compressor 2 is not possible or not sufficient. The compressors 2, 3 here are mutually independent, so that the fuel cell compressor 2 can convey the full required mass flow of air to the fuel cell unit FC, so that compensation of a pressure loss or of an air-mass flow loss is not necessary.

In this way, a plurality of advantages are associated with the air supply system 1 shown. On the one hand, savings in terms of line pieces can be implemented, because both compressors 2, 3 induct by way of the same intake opening. Moreover, only one air filter 4.1 has to be provided, which is provided in the single conjointly used intake opening 4. Finally, it can be achieved by way of a corresponding actuation of the valve 8 that both compressors 2, 3 can be operated in a more energy-efficient manner whenever possible, in that the fuel cell compressor 2 is utilized as a blower of the pneumatic system compressor 3.

A buffer tank (without reference sign) is provided in the pneumatic system intake line 6, or on the intake side 3.1 of the pneumatic system compressor 3 in the drawing. This buffer tank is to be considered optional and can also be omitted. Said buffer tank can be designed to equalize or reduce pressure or mass flow fluctuations emanating from the outlet side 2.2 of the fuel cell compressor 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Air supply system
1.1 Fuel cell outlet
1.2 Pneumatic system outlet
2 Fuel cell compressor
2.1 Intake side
2.2 Outlet side
3 Pneumatic system compressor
3.1 Intake side
3.2 Outlet side
4 Intake opening
4.1 Air filter
5 Fuel cell intake line
6 Pneumatic system intake line
8 Valve
8.1 First switch position
8.2 Second switch position
FC Fuel cell unit
PS Pneumatic system

What is claimed is:

1. An air supply system for a fuel cell unit and for a pneumatic system, comprising:
a fuel cell compressor which is designed to induct air from its intake side and, by way of its outlet side, convey said air to a fuel cell outlet of the air supply system, said fuel cell outlet being able to be connected to a fuel cell unit;
a pneumatic system compressor which is designed to induct air from its intake side and, by way of its outlet side, convey said air to a pneumatic system outlet of the air supply system, said pneumatic system outlet being able to be connected to a pneumatic system;
an intake opening of the air supply system;
a fuel cell intake line which connects the intake side of the fuel cell compressor to the intake opening; and
a pneumatic system intake line which connects the intake side of the pneumatic system compressor to the intake opening, wherein
the fuel cell compressor and the pneumatic system compressor are configured to induct air by way of the intake opening.

2. The air supply system as claimed in claim 1, wherein
the intake opening has an air filter.

3. The air supply system as claimed in claim 1, wherein
the fuel cell intake line has a separate air filter, and/or
the pneumatic system intake line has a separate air filter.

4. The air supply system as claimed in claim 1, wherein
an air mass flow detector is provided on an outlet side of the fuel cell compressor and/or at the fuel cell outlet to detect a mass flow of air conveyed by the fuel cell compressor and/or pressure generated by the fuel cell compressor.

5. The air supply system as claimed in claim 1, wherein
an air mass flow detector is provided on an outlet side of the pneumatic system compressor and/or at the pneumatic system outlet to detect mass flow of air conveyed by the pneumatic system compressor and/or pressure generated by the pneumatic system compressor.

6. The air supply system as claimed in claim 1, wherein
the pneumatic system intake line has a valve which, in a first switch position, is designed to establish a connection between the intake opening and the intake side of the pneumatic system compressor and, in a second switch position, to interrupt the connection between the intake opening and the intake side of the pneumatic system compressor.

7. The air supply system as claimed in claim 6, wherein
the valve, in the second switch position, is designed to establish a connection of the intake side of the pneumatic system compressor to the outlet side of the fuel cell compressor.

8. The air supply system as claimed in claim 7, wherein
the air supply system is designed so that in the second switch position of the valve there is additionally a connection from the outlet side of the fuel cell compressor to the fuel cell outlet.

9. The air supply system as claimed in claim 6, wherein
the air supply system is designed to switch the valve to the first switched state or to maintain the first switched state if a first condition is met.

10. The air supply system as claimed in claim 9, wherein
the first condition is undershooting or remaining below a first predetermined limit by the pressure or by the mass flow of air on the outlet side of the fuel cell compressor and/or at the fuel cell outlet, or wherein the first condition is a predetermined operating state of the air supply system.

11. The air supply system as claimed in claim 6, wherein
the air supply system is designed to increase power input of the fuel cell compressor and/or to reduce a flow resistance on the outlet side of the fuel cell compressor and/or at the fuel cell outlet if the valve is in the second switched state and a second condition is met.

12. The air supply system as claimed in claim 11, wherein
the second condition is undershooting or remaining below a second predetermined limit by the pressure or by the mass flow of air on the outlet side of the fuel cell compressor and/or at the fuel cell outlet, or wherein the second condition is a predetermined operating state of the air supply system.

13. The air supply system as claimed in claim 1, wherein
the pneumatic system comprises a pneumatic brake system and/or an air suspension system.

14. A commercial vehicle, comprising:
a fuel cell unit;
a pneumatic system; and
an air supply system as claimed in claim 1, wherein
the fuel cell outlet of the air supply system is connected to the fuel cell unit, and
the pneumatic system outlet of the air supply system is connected to the pneumatic system.

15. The vehicle as claimed in claim 14, wherein
the pneumatic system comprises a pneumatic brake system and/or an air suspension system.
